(19) United States
(12) Patent Application Publication
(10) Pub. No.: US 2020/0171714 A1
(43) Pub. Date: Jun. 4, 2020

(54) METHOD FOR PROTECTING A FASTENER JOINT

(71) Applicant: Ford Global Technologies, LLC, Dearborn, MI (US)

(72) Inventors: Thomas Norton, Ann Arbor, MI (US); Amanda Kay Freis, Ann Arbor, MI (US); Garret Sankey Huff, Ann Arbor, MI (US); Anthony J. Grima, South Rockwood, MI (US)

(73) Assignee: Ford Global Technologies, LLC, Dearborn, MI (US)

(21) Appl. No.: 16/203,684

(22) Filed: Nov. 29, 2018

(51) Int. Cl. B29C 35/08; B29C 43/18; B23P 6/00

(52) U.S. Cl. CPC B29C 35/0805; B29C 43/18; B29K 2995/002; B29C 2035/0827; B23P 6/00

(57) ABSTRACT

A method of protecting a repair joint having at least two workpieces joined by a fastener includes selecting a preformed functional body based on at least one joint characteristic and applying the preformed functional body to cover the fastener and at least a portion of one of the workpieces. Generally, the preformed functional body inhibits contamination or moisture ingress at a joint interface, and especially in a repair operation. The preformed functional body in one form defines a material that undergoes a color change to indicate a state of cure, and in another form is cured by UV light, moisture, or heat after application.

### FIELD

The present disclosure relates to mechanical fasteners and methods of repairing or sealing a joint having such mechanical fasteners.

### BACKGROUND

The statements in this section merely provide background information related to the present disclosure and may not constitute prior art.

Automobile body panels are typically assembled by fastening together sheets of metal or composite material. Fastening techniques for these sheets of material often include adhesive bonding, welding, and riveting, among others. Riveting pierces at least one of the workpieces being fastened, thus creating a potential contamination or moisture ingress path at the joint interface where the piercing occurs. To prevent or inhibit contamination of the joint, a sealant is generally applied by painting, brushing, or dispensing a continuous supply of flowable material along an interface between the rivet and a workpiece prior to installation of the rivet.

After an automobile has been in service for an extended period of time or has been damaged, these mechanically fastened joints may require repairs, which can lead to additional paths for contamination/moisture ingress.

The present disclosure addresses issues related to the repair of a joint through which a rivet or mechanical fastener has pierced at least one of the workpieces, among other repair and protection issues, and particularly related to automotive vehicles.

### SUMMARY

Generally, the present disclosure provides methods of protecting a repair joint having at least two workpieces and a fastener, in which a preformed functional body (e.g., a sealant) is provided to simplify the repair process.

In one form, a method of protecting a repair joint having at least two workpieces joined by a fastener is provided that comprises selecting a preformed functional body based on at least one joint characteristic and applying the preformed functional body to cover the fastener and at least a portion of one of the workpieces. The joint characteristic may include, but is not limited to, material of the workpieces, a head height of the fastener, a diameter of the fastener, a material of the fastener, and a surface area of the repair joint.

In one variation of this method, a compressive force is used to apply the preformed functional body to the repair joint. An amount of compressive force in one form is determined by at least one joint characteristic, and in another form is based on characteristics of the preformed functional body. In one form, the compressive force is applied by an applicator having a predetermined volume to control deformation of the preformed functional body.

In other variations of this method, the preformed functional body is partially cured prior to application to the repair joint interface, and the repair joint is prepared prior to applying the preformed functional body, such as by way of example applying a dehumidifier coating to the fastener and at least a portion of one of the workpieces.

In another form, the preformed functional body is cured by at least one of UV light, moisture, and heat after the preformed functional body is applied. Further, the preformed functional body may a material that undergoes a color change to indicate a state of cure.

In another form, the preformed functional body defines a dimple, and the preformed functional body is located relative to the fastener by the dimple.

In still another form, the preformed functional body is selected from a kit containing a plurality of preformed functional bodies, which are configured for different joint characteristics. The repair kit may also contain an optional applicator.

In another form of the present disclosure, another method of sealing a repair joint having at least two workpieces joined by a fastener is provided that comprises selecting a preformed sealant body based on at least one joint characteristic and applying the preformed sealant body with a compressive force determined by at least one joint characteristic to cover the fastener and at least a portion of one of the workpieces.

In one variation of this method, the compressive force is applied by an applicator having a predetermined volume to control deformation of the preformed sealant body. In another variation, the preformed sealant body defines a material that undergoes a color change to indicate a state of cure. In still another form, the preformed sealant body is cured by at least one of UV light, moisture, and heat after being applied to the repair joint. Further still, a dehumidifier coating may be applied to the repair joint prior to application of the preformed sealant body. Also, the preformed functional body may be selected from a kit containing a plurality of preformed functional bodies, wherein the plurality of preformed functional bodies are designed for different repair joint characteristics.

In another method according to the present disclosure, a repair joint having at least two workpieces joined by a fastener is sealed by preparing the repair joint, selecting a preformed sealant body based on joint characteristics selected from the group consisting of joint material, fastener type, fastener material, fastener size, joint environment, joint geometry, sealant characteristics, and desired curing method, placing the preformed sealant body over the fastener and at least a portion of one of the workpieces, applying a compressive force determined by at least one joint characteristic to the preformed sealant body by an applicator having a predetermined volume to control deformation of the preformed sealant body, and curing the preformed sealant body by at least one of UV light, moisture, and heat after being applied to the repair joint. In a variation of this method, the preformed sealant body defines a material that undergoes a color change to indicate a state of cure.

It should be noted that the features set out individually in the following description can be combined with each other in any technically advantageous manner and set out other forms of the present disclosure. The description further characterizes and specifies the present disclosure in particular in connection with the Figures.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a side cross-sectional view of a repair joint according to the prior art;

FIG. 2 is a perspective view of a preformed functional body constructed according to the teachings of the present disclosure;

FIG. 3 a flowchart illustrating a repair method utilizing a preformed functional body according to the teachings of the present disclosure;

FIG. 4 is a side cross-sectional view of a repair joint as a preformed functional body is applied to a repair joint, according to the teachings of the present disclosure;

FIG. 5 is a side cross-sectional view of a repair joint illustrating one form of an applicator for applying a force to a preformed functional body according to the teachings of the present disclosure;

FIG. 6 is a side cross-sectional view of a repair joint after a preformed functional body has been applied to the repair joint, according to the teachings of the present disclosure; and

FIG. 7 is a schematic view of a repair kit according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

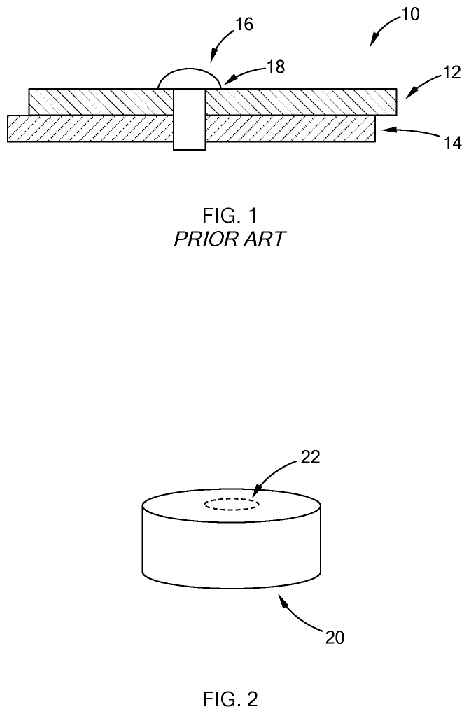

As shown in FIG. 1, a joint assembly according to the prior art is illustrated and generally indicated by reference numeral 10. As shown, the joint assembly includes two workpieces 12, 14 and a fastener 16 joining the workpieces 12, 14. The fastener 16 could be a SPR (self-piercing rivet), screw or any other known fastener, which functions to secure or fasten the two workpieces 12, 14 together. The fastener 16 is illustrated as piercing both workpieces 12, 14, however, for application of the present disclosure, the fastener 16 could be at any depth, angle, or orientation relative to the workpieces 12, 14. For example, the fastener 16 could pierce the upper workpiece 12 completely and extend partially into the lower workpiece 14 while remaining within the scope of the present disclosure.

A joint interface 18 is created in the general area where the fastener 16 passes through the workpieces 12, 14, which may be through one or both of the workpieces 12, 14, thus providing a potential path for contamination or moisture ingress. Inhibiting the ingress of contamination or moisture into the joint interface 18 is addressed by the teachings of the present disclosure, as set forth in greater detail below.

Referring now to FIG. 2, an innovative preformed functional body 20 is provided to inhibit contamination or moisture ingress at a joint interface 18, and especially in a repair operation. Generally, the preformed functional body 20 is applied to cover the fastener 16 and at least a portion of one of the workpieces adjacent to the fastener 16 (workpiece 12 as shown in FIG. 1), which is described in greater detail below.

As used herein, the term “preformed functional body” should be construed to mean any physical body that has a predetermined shape, size, and/or material composition to perform any function at the joint interface 18 such as sealing, coating, priming, surface treatment, and marking (e.g., decorative, identification), among others.

Although the preformed functional body 20 is shown as a disc or puck, the shape, size, material, features and properties of the preformed functional body 20 are dependent on the specific joint characteristics to which the preformed functional body 20 will be applied. The joint characteristics used determine the appropriate properties for the preformed functional body 20 include, but are not limited to, the material of the workpieces 12/14, head height of the fastener 16, diameter of the fastener 16, material of the fastener 16, the surface area of the joint, and desired area of coverage, among others. In one form, the material used for the preformed functional body 20 is a sealant, an adhesive, or any other material that would provide protection against the ingress of contaminants or moisture into the joint interface 18, such as by way of example a two-part epoxy. The preformed functional body 20 may also be partially cured prior to use, which is described in greater detail below. Partial curing of the preformed functional body 20 allows initial characteristics to be obtained prior to the repair, such as structural rigidity. In one form, the preformed functional body, such as the sealant, is a material that undergoes an irreversible structural cure, i.e., a thermoset material. It should be understood, however, that a thermoplastic material, or a material that undergoes a reversible change, may be used provided that a temperature during subsequent operation after repair is below the glass transition temperature.

In one form, the preformed functional body 20 possesses an adhesive quality that allows the preformed functional body 20 to adhere to the fastener and workpiece 12. The preformed functional body 20 may also be comprised of a material that undergoes a color change indicating a state of cure. Table 1 below contains a list of representative color changing materials that could be used for a preformed functional body 20, in which the desired material would undergo an irreversible color change during curing.

TABLE 1
Example Color Changing Materials

| Inorganic Material | Color Change |
|---|---|
| Cul | gray-tan → orange |
| NH₄V0₃ | white → brown |
| | brown → black |
| CoCO₂ | violet → black |
| Mn(NH₄)P₂O₇ | violet → white |
| NiC₂O₄ | light blue → black |

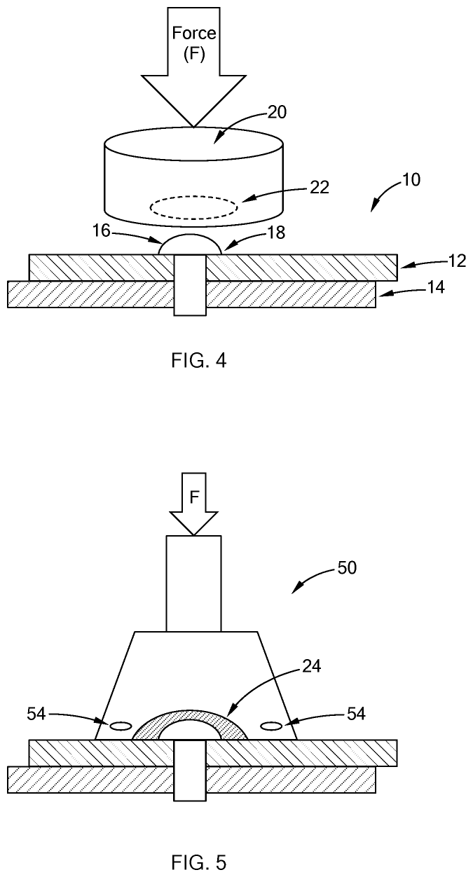

As shown in FIG. 2, the preformed functional body 20 may contain a dimple 22 in a surface in order to provide clearance/space for the head of fastener 16 during application of the preformed functional body over the fastener 16. (Also shown in FIG. 4). This clearance allows for improved application of the preformed functional body 20 over the fastener 16. The size, shape and location of this dimple 22 is dependent on the fastener 16, including the fastener head shape and fastener head height, and/or the properties of the preformed functional body 20. In one form, the preformed functional body may also include a vent 23, or opening, extending from dimple 22 to the outside of the preformed functional body 20 in order to assist with the removal of air around the fastener 16 and joint interface 18 during application of the preformed functional body 20 to the joint interface 18. This vent 23 could also be sealed before the completion of the application process or may be sealed inherently with deformation of the preformed functional body 20. The vent 23 may be located in any position and/or orientation relative to the preformed functional body 20 and is not limited to the specific illustration herein. The dimple 22 may also be used in order to properly locate the preformed functional body 20 relative to head of the fastener 16.

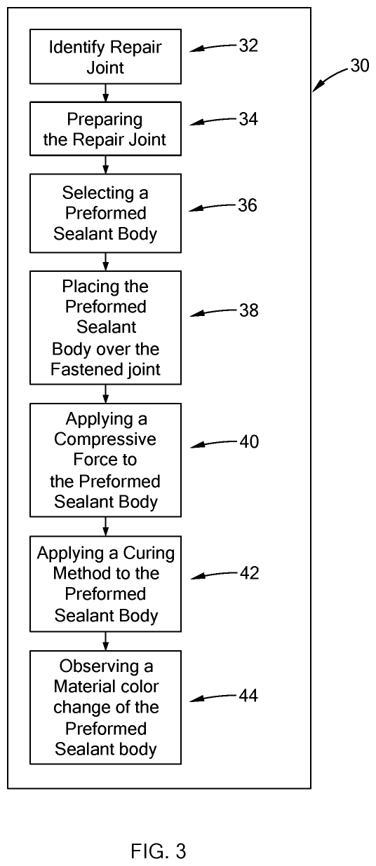

Referring now to FIG. 3, a method of protecting a repair joint is illustrated generally by reference numeral 30. As used herein, the term “repair joint” should be construed to mean a fastener joint that is repaired or reworked in any application where joint protection is desired, whether after entering initial service or during initial manufacturing in a production facility, among other scenarios.

As shown, identifying the repair joint 32 is a step in the method 30, and more specifically, the joint characteristics of the repair joint are used to select a preformed function body to be applied. As set forth above, the joint characteristics include, but are not limited to, the material of the workpieces 12/14, head height of the fastener 16, diameter of the fastener 16, material of the fastener 16, the surface area of the joint, and desired area of coverage, among others. In one form of the present disclosure, the surface area of the joint to be covered by the preformed functional body 20 is minimally defined as the surface area of the fastener head plus an additional 10%.

The method 30 continues with preparing the repair joint 34. Preparing the repair joint involves cleaning or clearing the joint such that it is generally free of contaminants and moisture prior to applying the preformed functional body 20. This preparation can be any process, chemical, mechanical, or otherwise, that is applied to the joint 10. One beneficial preparation is to apply a dehumidifier coating to the joint interface 18 prior to repairing the joint 10, thereby reducing the amount of moisture at the joint interface 18.

Next, a preformed functional body 20 is selected in step 36. Determination of the geometry and material properties for a specific preformed functional body 20 is dependent upon the joint characteristics identified in step 32. The joint characteristics used to determine the selection of a preformed functional body 20 could be any characteristic that could affect integrity of the joint interface and ingress of contamination, including but not limited to those set forth above relative to step 32. The preformed functional body 20 may be partially cured prior to application to obtain the desired properties and maybe selected from, but is not limited to, epoxy- or PVC-based polymers.

After selection of a specific preformed functional body 20, the preformed functional body 20 is placed over the joint interface 18 in step 38 and also as shown FIG. 4. If the optional dimple 22 is part of the preformed functional body 20, the dimple 22 aligns the preformed functional body 20 into position over the fastener 16.

After the preformed functional body 20 is placed over the fastener 16 and workpiece 12, a force F is applied to the preformed functional body 20 in step 40 and also as shown in FIG. 4. This force may be gravity, an externally applied compressive force, or a vacuum. The force, which in one form is a compressive force, may be applied by hand or using an optional applicator (described in greater detail below). The amount of force F is based upon characteristics of the preformed functional body selected in step 36, including but not limited to the elasticity of the preformed functional body. The force F assists in the removal of potential air pockets between the preformed functional body 20 and the joint assembly 10 and shapes the preformed functional body 20 to conform to the fastener 16 and upper workpiece 12.

Referring to FIG. 5, an optional applicator 50 is shown, which includes an end portion 52 having an internal cavity 54 that is placed over the preformed functional body 20. The applicator 50 transmits force F to the preformed functional body 20 through manual actuation or by applying a compressive force though another means such as air pressure. As the force F is transmitted to the preformed functional body 20, the internal cavity 54 shapes the preformed functional body to conform and adhere to the fastener 16, joint interface 18 and workpiece 12. The internal cavity 54 thus has a predetermined volume to control deformation of the preformed functional body 20. Further, the internal cavity 54 may also be designed to impart a desired surface finish or texture to the preformed sealant body 20. (FIG. 5 shows the preformed functional body 20 in a molded/formed state and the joint 10 after application of force F).

After application to the repair joint 18, the preformed functional body 20 may undergo a curing operation in step 42 (FIG. 3). Methods for curing the preformed functional body 20 include but not limited to heat, UV (ultraviolet light), moisture, heat, along with time, temperature, and pressure profiles. In an optional form, the preformed functional body 20 undergoes a color change, indicating a state of cure during the curing process. By observing the color change, the state of cure can be determined in step 44, thus indicating the altered characteristics of the preformed functional body 20. The curing may be a complete or partial cure of the preformed functional body 20. The applicator 50 may include an integral curing mechanism 56 such as UV light, or the repair method may employ a separate curing device (shown and described below relative to FIG. 7) to cure the preformed functional body 20.

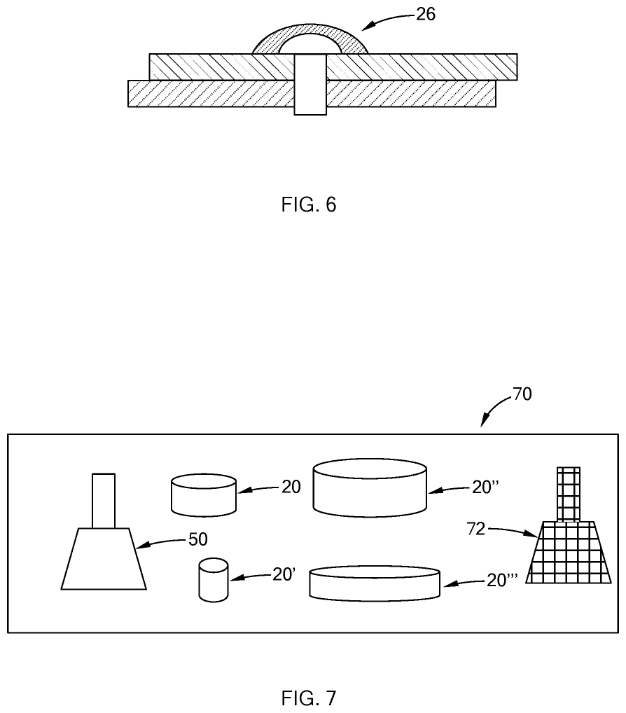

Referring now to FIG. 6, a completed repair joint 60 with the molded, and optionally cured, preformed functional body 20 is shown. The preformed functional body 20 thus covers a head of the fastener 16 and at least a portion of one of the workpieces 12, 14.

FIG. 7 is an example of a kit 70 that includes a plurality of preformed functional bodies 20, 20′, 20″, 20″′ having a diversity of physical and chemical characteristics. The diversity of characteristics allows the most effective preformed functional body 20 to be selected based on the specific joint to be protected and a convenient way to repair a variety of types of repair joints. The kit 70 may also include the optional applicator 50 and optional curing device 72, which may be a lamp or UV device, among others.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

As used herein, the phrase at least one of A, B, and C should be construed to mean a logical (A OR B OR C), using a non-exclusive logical OR, and should not be construed to mean “at least one of A, at least one of B, and at least one of C.

What is claimed is:

1. A method of protecting a repair joint having at least two workpieces joined by a fastener comprising:
selecting a preformed functional body based on at least one joint characteristic; and
applying the preformed functional body to cover the fastener and at least a portion of one of the workpieces.

2. The method according to claim 1, wherein the preformed functional body is applied with a compressive force.

3. The method according to claim 2, wherein an amount of the compressive force is determined by at least one of a joint characteristic and a characteristic of the preformed functional body.

4. The method according to claim 2, wherein the compressive force is applied by an applicator having a predetermined volume to control deformation of the preformed functional body.

5. The method according to claim 1, wherein the preformed functional body is partially cured prior to application to the repair joint interface.

6. The method according to claim 1 further comprising preparing the repair joint before applying the preformed functional body.

7. The method according to claim 6, wherein preparing the repair joint includes applying a dehumidifier coating to the fastener and at least a portion of one of the workpieces.

8. The method according to claim 1 further comprising curing the preformed functional body by at least one of UV light, moisture, and heat after the preformed functional body is applied.

9. The method according to claim 1, wherein the preformed functional body defines a material that undergoes a color change to indicate a state of cure.

10. The method according to claim 1, wherein the preformed functional body defines a dimple and is located relative to the fastener by the dimple.

11. The method according to claim 1, wherein the joint characteristic is selected from the group consisting of material of the workpieces, a head height of the fastener, a diameter of the fastener, a material of the fastener, and a surface area of the repair joint.

12. The method according claim 1, wherein the preformed functional body is selected from a kit containing a plurality of preformed functional bodies, wherein the plurality of preformed functional bodies are configured for different joint characteristics.

13. A method of sealing a repair joint having at least two workpieces joined by a fastener comprising;
selecting a preformed sealant body based on at least one joint characteristic; and
applying the preformed sealant body with a compressive force determined by the at least one joint characteristic to cover the fastener and at least a portion of one of the workpieces.

14. The method according to claim 13, wherein the compressive force is applied by an applicator having a predetermined volume to control deformation of the preformed sealant body.

15. The method according to claim 13, wherein the preformed sealant body defines a material that undergoes a color change to indicate a state of cure.

16. The method according to claim 13, wherein the preformed sealant body is cured by at least one of UV light, moisture, and heat after being applied to the repair joint.

17. The method according to claim 13 further comprising applying a dehumidifier coating to the repair joint prior to application of the preformed sealant body.

18. The method according to claim 13, wherein the preformed functional body is selected from a kit containing a plurality of preformed functional bodies, wherein the plurality of preformed functional bodies are designed for different repair joint characteristics.

19. A method of sealing of a repair joint having at least two workpieces joined by a fastener comprising;
preparing the repair joint;
selecting a preformed sealant body based on joint characteristics selected from the group consisting of joint material, fastener type, fastener material, fastener size, joint environment, joint geometry, sealant characteristics, and desired curing method;
placing the preformed sealant body over the fastener and at least a portion of one of the workpieces;
applying a compressive force determined by at least one joint characteristic to the preformed sealant body by an applicator having a predetermined volume to control deformation of the preformed sealant body; and
curing of the preformed sealant body by at least one of UV light, moisture, and heat after being applied to the repair joint.

20. The method according to claim 19, wherein the preformed sealant body defines a material that undergoes a color change to indicate a state of cure.
